(19) United States
(12) Patent Application Publication
(10) Pub. No.: US 2015/0081850 A1
(43) Pub. Date: Mar. 19, 2015

(54) SYSTEMS AND METHODS FOR ESTABLISHING NON DATA DELIVERY CHANNEL TO CHECK DEVICE CAPABILITIES

(71) Applicant: Infosys Limited, Bangalore (IN)

(72) Inventor: Gaurav Mittal, Delhi (IN)

(21) Appl. No.: 14/486,345

(22) Filed: Sep. 15, 2014

(30) Foreign Application Priority Data
Sep. 19, 2013 (IN) 4214/CHE/2013

(51) Int. Cl. H04L 29/06

(52) U.S. Cl. CPC H04L 65/60
USPC 709/219

(57) ABSTRACT

This technology relates to systems and methods for establishing a non-data delivery channel for checking device capabilities to send one or more media contents. This technology involves receiving request to deliver media contents to telecommunication devices. Then, a non data delivery channel is established with the telecommunication devices by sending a message to the devices. In response to the message, one or more device capabilities and user preferences are sent by the devices and received by the server. The server analyzes the device capabilities and user preferences and selects the most appropriate channel to deliver the requested media contents. Finally, the server delivers the media contents through the selected delivery channel. If the device capabilities do not meet the predefined benchmark, then an error message is sent to the device and if the user preferences cannot be fulfilled then an appropriate message is sent to the device.

This application claims the benefit of Indian Patent Application Filing No. 4214/CHE/2013, filed Sep. 19, 2013, which is hereby incorporated by reference in its entirety. Additionally, this application is a patent of addition of Indian Patent Application Serial No. 1232/CHE/2013 filed on Mar. 21, 2013, which is incorporated herein by reference in its entirety.

### FIELD

The invention relates generally to a method and system delivering content on a hand-held device, and in particular, to a system and method for establishing non data delivery channel with the device for checking one or more device capabilities to send one or more media contents.

### BACKGROUND

There is increasing number of handheld devices which request to deliver one or more media contents from the server to the device. Before transferring the content to the device, the server is required to check device capabilities. Presently, the device capability transfer between a client and server happens via an active data connection which establishes the link between the client and the server facilitating the transfer. In this process, the client sends a SMS requesting for particular media content to server and in response of that server sends a download link pointing to the content server. The user is prompted to click on the download link to establish a channel through the wireless data network. Next the user's device capabilities are transferred to the content server through wireless data network and the content server reads the user device capabilities and responds to the request for content accordingly. But this method has some drawbacks. Presently, the download link can be accessed to facilitate transfer of device capability only if a data connection is active on the device. The user is always charged with an amount for clicking the download link but the capability transfer may not get completed due to the lack of active data connection capability. Further, in the absence of knowledge of device capabilities and preferences server has no way to ensure that the content requested/pushed to the user's device necessarily works on it.

### SUMMARY

The present technique overcomes the above mentioned limitations by establishing a communication link between two telecom devices using a non data channel in order to transfer capability parameters and user preferences between two devices.

According to the present embodiment, a method for establishing non data delivery channel for checking device capabilities to send one or more media contents is disclosed. The method includes receiving a request from a telecommunication device to deliver the one or more media contents and then establishing a non data delivery channel with the telecommunication device by sending a message to the device. Then, one or more capability parameters of the device and one or more preferences of a user of the device are received through the non data delivery channel, wherein the one or more capability parameters and the one or more preferences are sent by the device in response to the message. Thereafter, a most appropriate delivery channel is selected based on the one or more device capability parameters, one or more network parameters and the one or more preferences of the user. Finally, the one or more media contents are delivered through the selected delivery channel.

In an additional embodiment, a system for establishing non data delivery channel for checking device capabilities to send one or more media contents is disclosed. The system includes a request receiving module, a non data delivery channel establishment module, a device capability and user preference receiving module, a delivery channel selection module and a media content delivery module. The request receiving module is configured to receive a request from a telecommunication device to deliver the one or more media contents. The non data delivery channel establishment module is configured to establish a non data delivery channel with the telecommunication device by sending a message to the device. The device capability and user preference receiving module is configured to receive one or more capability parameters of the device and one or more preferences of a user of the device through the non data delivery channel, wherein the one or more capability parameters and the one or more preferences are sent by the device in response to the message. The delivery channel selection module is configured to select a most appropriate delivery channel based on the one or more device capability parameters, one or more network parameters and the one or more preferences of the user. The media content delivery module is configured to deliver the one or more media contents through the selected delivery channel.

In another embodiment, a computer readable storage medium for establishing non data delivery channel for checking device capabilities to send one or more media contents is disclosed. The computer readable storage medium which is not a signal stores computer executable instructions for receiving a request from a telecommunication device to deliver the one or more media contents, establishing a non data delivery channel with the telecommunication device by sending a message to the device, receiving one or more capability parameters of the device and one or more preferences of an user of the device through the non data delivery channel, wherein the one or more capability parameters and the one or more preferences are sent by the device in response to the message, selecting a most appropriate delivery channel based on the one or more device capability parameters, one or more network parameters and the one or more preferences of the user and delivering the one or more media contents through the selected delivery channel.

### BRIEF DESCRIPTION OF THE DRAWINGS

Various embodiments of the invention will, hereinafter, be described in conjunction with the appended drawings. There is no intention to limit the scope of the invention to such blocks or objects, or to any particular technology. Instead these simplified diagrams are presented by way of illustration to aid in the understanding of the logical functionality of one or more aspects of the instant disclosure and is not presented by way of limitation.

FIG. 1 is a computer architecture diagram illustrating a computing system capable of implementing the embodiments presented herein.

FIG. 2 is a flowchart, illustrating a method for establishing non data delivery channel for checking device capabilities to send one or more media contents, in accordance with an embodiment of the present invention.

FIG. 3 is a block diagram illustrating a system for establishing non data delivery channel for checking device capabilities to send one or more media contents, in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present invention provide a system and method for establishing non data delivery channel for checking device capabilities to send one or more media contents. This involves receiving request to deliver media contents to telecommunication devices. Then, a non data delivery channel is established with the telecommunication devices by sending a message to the devices.

In response to the message, one or more device capabilities and user preferences are sent by the devices and received by the server. Server analyzes the device capabilities and user preferences and selects the most appropriate channel to deliver the requested media contents. Finally, the server delivers the media contents through the selected deliver channel. If the device capabilities do not meet the predefined benchmark, then an error message is sent to the device and if the user preferences can not be fulfilled then an appropriate message is sent to the device.

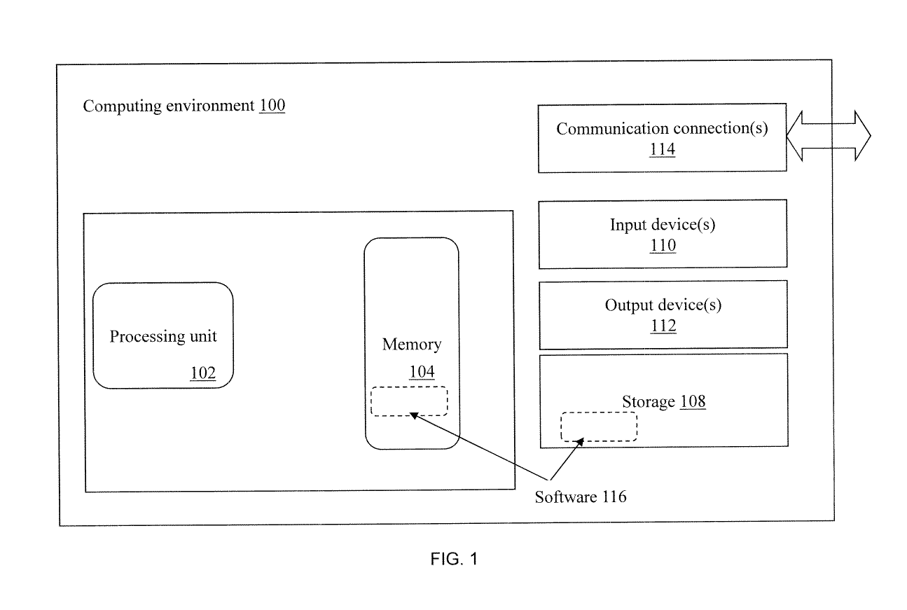

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

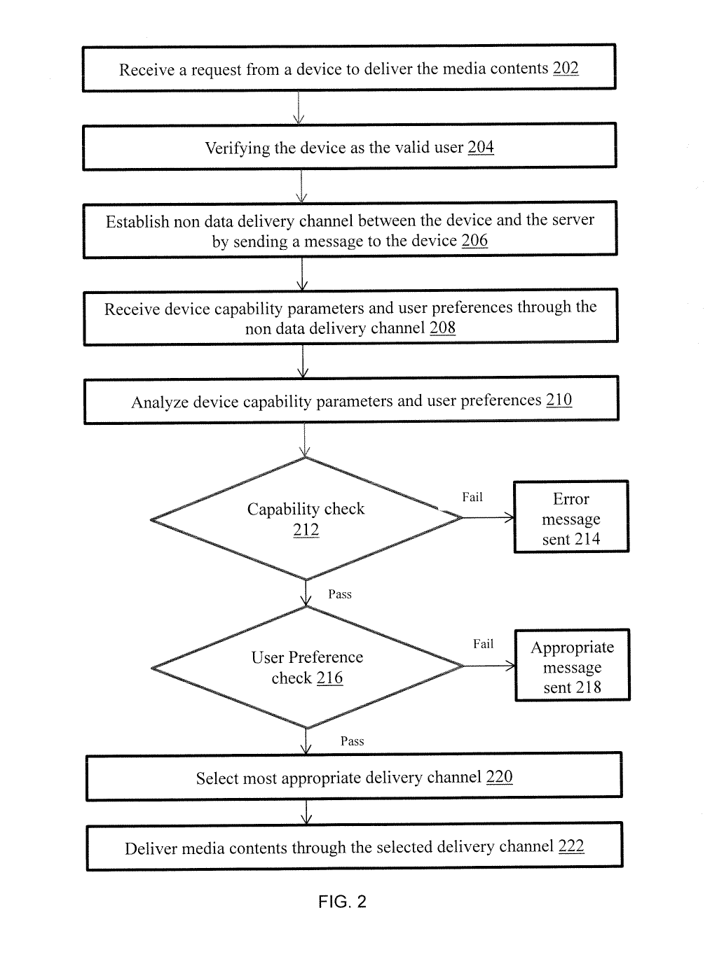

FIG. 2 is a flowchart, illustrating a method for establishing non data delivery channel for checking device capabilities to send one or more media contents, in accordance with an embodiment of the present invention. A request from a telecommunication device is received to deliver one or more media contents, as in step 202. The request can be in a form of short message service. The server then verifies the telecommunication device as a valid user to avail its service, as in step 204. Upon confirming the same, a non data delivery channel is established with the telecommunication device by sending a message, as in step 206. The non data delivery channel can be established by sending a Short Message Service (SMS) or Unstructured Supplementary Service Data (USSD) message to the device. The message received by the device is decoded and in response to that device capability parameters and user preferences are sent to the server through the established non data delivery channel, as in step 206. The device capability parameters may include but are not limited to type, extension, codec, size, screen resolution, screen size, telecommunication device model, memory, language support and format of the media contents. The user preferences may include but are not limited to media preference, payments preference, delivery preference, user interface preference, language preference, format of media content. The received device capabilities and user preferences are analyzed, as in step 210. The server compares the received capability parameters with the parameters required for the media content requested by the user, as in step 212. For the media content accessible from the content server, predefined benchmarks are available. A benchmark for particular media content includes minimum capability parameters required for a device to access the media content. After receiving the user device's capability parameters, the content server parses and compares the device capability parameters with the benchmarks associated with the requested media content. If the telecommunication device does not have required capacity to receive the requested media contents, then an error message is sent to the device, as in step 214. At step 216, the check is performed to verify if the media contents can be delivered as per the user preferences. If the media contents can not be delivered as per the user preferences, then an appropriate message is sent to the device, as in step 218. The appropriate message may include the problem statement and also may suggest some other options to deliver the contents. If the device capability parameters and user preferences pass the test, then the most appropriate delivery channel is selected based on device capability parameters, network preferences and user preferences, as in step 220. The most appropriate delivery channel may include SMS, USSD, GPRS/2G, 2.5G, 3G, 4G, web and so on. Finally, the media contents are delivered based on the user preferences, device capabilities through the selected delivery channel, as in step 222.

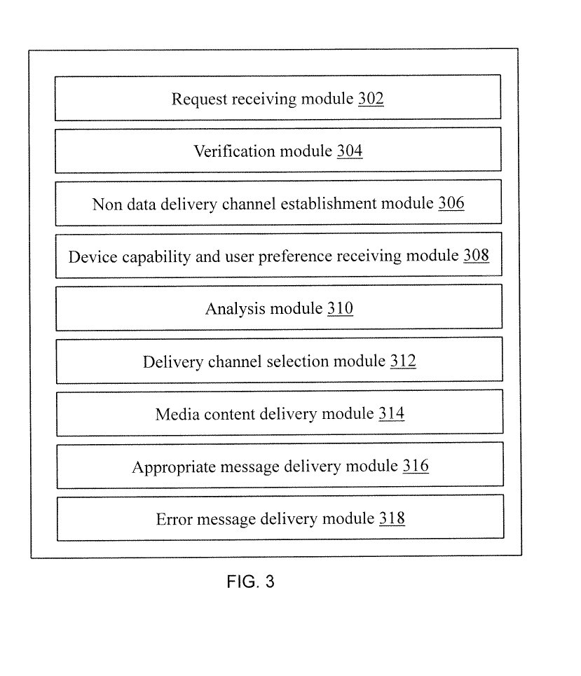

FIG. 3 is a block diagram illustrating a system for establishing non data delivery channel for checking device capabilities to send one or more media contents, in accordance with an embodiment of the present invention. The system includes a request receiving module 302, a verification module 304, a non data delivery channel establishment module 306, a device capability and user preference receiving module 308, an analysis module 310, a delivery channel selection module 312, a media content delivery module 314, an appropriate message delivery module 316 and an error message delivery module 318. The request receiving module 302 is configured to receive a request from a telecommunication device to deliver the one or more media contents. The verification module 304 is configured verify the device as a valid user. The non data delivery channel establishment module 306 is configured to establish a non data delivery channel with the telecommunication device by sending a message to the device. The non data delivery channel can be established by sending a

Short Message Service (SMS) or Unstructured Supplementary Service Data (USSD) message to the device. The device capability and user preference receiving module 308 is configured to receive one or more capability parameters of the device and one or more preferences of a user of the device through the non data delivery channel, wherein the one or more capability parameters and the one or more preferences are sent by the device in response to the message. The detail regarding device capability parameters and user preferences are described with reference to FIG. 2 hereinabove. The analysis module 310 is configured to analyze the one or more capability parameters of the device and the one or more preferences of the user. The delivery channel selection module 312 is configured to select a most appropriate delivery channel based on the one or more device capability parameters, one or more network parameters and the one or more preferences of the user. The media content delivery module 314 is configured to deliver the one or more media contents through the selected delivery channel. The appropriate message delivery module 316 is configured to deliver an appropriate message through the non data delivery channel to the device if the one or more user preferences cannot be fulfilled. The error message delivery module 318 is configured to deliver an error message to the device from the processor through the non data delivery channel if the one or more capability parameters do not fulfill the one or more predefined benchmarks. Details regarding the same are discussed with reference to FIG. 2 hereinabove.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

We claim,

1. A method for delivering media content, the method comprising:
receiving, by a content delivery computing device, a request from a telecommunication device to deliver media content;
establishing, by the content delivery computing device, a non data delivery channel with the telecommunication device, the establishing comprising sending a message to the telecommunication device;
receiving, by the content delivery computing device, one or more capability parameters of the telecommunication device and one or more preferences of a user of the telecommunication device through the non data delivery channel, wherein the capability parameters and the preferences are sent by the telecommunication device in response to the message;
selecting, by the content delivery computing device, a delivery channel based on one or more of the capability parameters, one or more network parameters, or the preferences; and
delivering, by the content delivery computing device, the media content through the selected delivery channel to the telecommunication device.

2. The method as claimed in claim 1, further comprising verifying, by the content delivery computing device, the user of the telecommunication device as a valid user.

3. The method as claimed in claim 1, wherein the non data delivery channel complies with a protocol selected from a Short Message Service (SMS) protocol or an Unstructured Supplementary Service Data (USSD) protocol.

4. The method as claimed in claim 1, wherein the preferences comprise one or more of a media preference, a payment preference, a delivery preference, a user interface preference, a language preference, or a format of media content.

5. The method as claimed in claim 1, wherein the capability parameters comprise one or more of a type, an extension, a codec, a size, a screen resolution, a screen size, a telecommunication device model, telecommunication device memory characteristic, a language support of the telecommunication device , or a format of the media content.

6. The method as claimed in claim 1, further comprising analyzing, by the content delivery computing device, one or more of the capability parameters or the preferences, wherein the capability parameters are analyzed based on one or more predefined benchmarks.

7. The method as claimed in claim 1, further comprising delivering, by the content delivery computing device, another message through the non data delivery channel to the telecommunication device when the user preferences cannot be fulfilled.

8. A content delivery computing device, comprising a processor and a memory coupled to the processor which is configured to be capable of executing programmed instructions comprising and stored in the memory to:
receive a request from a telecommunication device to deliver media content;
establish a non data delivery channel with the telecommunication device comprising sending a message to the telecommunication device;
receive one or more capability parameters of the telecommunication device and one or more preferences of a user of the telecommunication device through the non data delivery channel, wherein the capability parameters and the preferences are sent by the telecommunication device in response to the message;
select a delivery channel based on one or more of the capability parameters, one or more network parameters, or the preferences; and
deliver the media content through the selected delivery channel to the telecommunication device.

9. The content delivery computing device as claimed in claim 8, wherein the processor coupled to the memory is further configured to be capable of executing at least one additional programmed instruction comprising and stored in the memory to verify the user of the telecommunication device as a valid user.

10. The content delivery computing device as claimed in claim 8, wherein the non data delivery channel complies with a protocol selected from a Short Message Service (SMS) protocol or an Unstructured Supplementary Service Data (USSD) protocol.

11. The content delivery computing device as claimed in claim 8, wherein the preferences comprise one or more of a media preference, a payment preference, a delivery preference, a user interface preference, a language preference, or a format of media content.

12. The content delivery computing device as claimed in claim 8, wherein the capability parameters comprise one or more of a type, an extension, a codec, a size, a screen resolution, a screen size, a telecommunication device model, telecommunication device memory characteristic, a language support of the telecommunication device , or a format of the media content.

13. The content delivery computing device as claimed in claim 8, wherein the processor coupled to the memory is further configured to be capable of executing at least one additional programmed instruction comprising and stored in the memory to analyze one or more of the capability parameters or the preferences, wherein the capability parameters are analyzed based on one or more predefined benchmarks.

14. The content delivery computing device as claimed in claim 8, wherein the processor coupled to the memory is further configured to be capable of executing at least one additional programmed instruction comprising and stored in the memory to deliver another message through the non data delivery channel to the telecommunication device when the user preferences cannot be fulfilled.

15. A non-transitory computer readable medium having stored thereon instructions for delivering media content comprising executable code which when executed by a processor, causes the processor to perform steps comprising:
receiving a request from a telecommunication device to deliver media content;
establishing a non data delivery channel with the telecommunication device, the establishing comprising sending a message to the telecommunication device;
receiving one or more capability parameters of the telecommunication device and one or more preferences of a user of the telecommunication device through the non data delivery channel, wherein the capability parameters and the preferences are sent by the telecommunication device in response to the message;
selecting a delivery channel based on one or more of the capability parameters, one or more network parameters, or the preferences; and
delivering the media content through the selected delivery channel to the telecommunication device.

16. The non-transitory computer readable medium as claimed in claim 15, wherein the machine executable code when executed by the processor further causes the processor to perform steps further comprising verifying the user of the telecommunication device as a valid user.

17. The non-transitory computer readable medium as claimed in claim 15, wherein the non data delivery channel complies with a protocol selected from a Short Message Service (SMS) protocol or an Unstructured Supplementary Service Data (USSD) protocol.

18. The non-transitory computer readable medium as claimed in claim 15, wherein the preferences comprise one or more of a media preference, a payment preference, a delivery preference, a user interface preference, a language preference, or a format of media content.

19. The non-transitory computer readable medium as claimed in claim 15, wherein the capability parameters comprise one or more of a type, an extension, a codec, a size, a screen resolution, a screen size, a telecommunication device model, telecommunication device memory characteristic, a language support of the telecommunication device , or a format of the media content.

20. The non-transitory computer readable medium as claimed in claim 15, wherein the machine executable code when executed by the processor further causes the processor to perform steps further comprising analyzing one or more of the capability parameters or the preferences, wherein the capability parameters are analyzed based on one or more predefined benchmarks.

21. The non-transitory computer readable medium as claimed in claim 15, wherein the machine executable code when executed by the processor further causes the processor to perform steps further comprising delivering another message through the non data delivery channel to the telecommunication device when the user preferences cannot be fulfilled.
